(19) United States
(12) Patent Application Publication
(10) Pub. No.: US 2006/0274910 A1
(43) Pub. Date: Dec. 7, 2006

(54) Portable media reproduction system

(75) Inventors: Eran Schul, Milford, PA (US); Eric Aaron Langberg, Milford, PA (US); David Burke, Henryville, PA (US)

Correspondence Address: GREENBERG-TRAURIG, 1750 TYSONS BOULEVARD, 12TH FLOOR, MCLEAN, VA, 22102, US

(73) Assignee: Altec Lansing Technologies, Inc., Milford, PA (US)

(21) Appl. No.: 11/143,945

(22) Filed: Jun. 3, 2005

(51) Int. Cl. H04R 1/02; H04R 9/06

(52) U.S. Cl. 381/334

(57) ABSTRACT

A portable system capable of receiving audio signals from one or more sources and reproducing the signals via speakers contained therein. The portable media reproduction system includes a docking component for communicatively coupling a portable media player device to the portable media reproduction system, thereby reducing desktop clutter and simplifying connecting the portable media reproduction system with the media player device. The speaker component of the portable media reproduction system can preferably be engaged with a base component of the system, thereby protecting the docking component during transport and reducing the overall size of the system for improved portability.

### PRIORITY CLAIM

This application claims priority to U.S. patent application Ser. No. 10/836,113 filed Apr. 30, 2004, the entire disclosure of which is incorporated herein by reference. This application is a continuation-in-part thereof. This application further claims priority to U.S. Design patent application Ser. No. 29/191,799, filed Oct. 15, 2003, which is hereby incorporated by reference in its entirety.

### FIELD OF THE INVENTION

The present invention relates to the field of portable media playback equipment, and in particular to portable devices for reproducing audio signals.

### BACKGROUND OF THE INVENTION

The past several decades have seen remarkable advances in audio and video reproduction equipment, particularly equipment that allows a variety of audio tracks to be carried or transported with a user from one location to another. Such equipment includes, e.g., equipment for digitally recording, editing, mixing, producing, storing and reproducing audio tracks. Digital files are advantageous for several reasons, including the fact that running error correction algorithms on the files can guarantee that the audio track data in the files is properly stored, which means that the audio can be faithfully reproduced even where an underlying recording medium induces errors or where errors are induced in the copy process. Another advantage of digital files is that reproduction equipment can precisely control the speed at which the audio track is played, thereby effectively guaranteeing consistent playback.

In recent years, new algorithms for storing audio tracks have emerged. One of the more popular of these new audio track storage algorithms is the Motion Picture Entertainment Group level 3 algorithm, commonly referred to as the “MP3” algorithm. The MP3 algorithm uses a variety of techniques, including allowing users to vary the audio track sampling rate as the audio track is recorded, varying the number of bits used to represent a given frequency range, and the like, to generate digital audio track files that are significantly smaller than those used on CD's. This means that users can carry more audio data files on a given medium than they could in the past. For example, a typical seventy-two minute audio CD holds approximately 650 MB of data. Depending on the compression methods chosen, a 650 MB CD-ROM has sufficient capacity for several hours of compressed music.

As digital storage capacity continues to increase and compression algorithms continue to advance, users are able to carry more and more of the music they like with them. This has resulted in the incorporation of audio track reproduction capabilities in an ever-increasing array of audio-capable devices, including, but not limited to, digital cameras, portable digital assistants (“PDA's”), wireless telephones, and the like. Several other devices, generally referred to as portable media players (“PMP's”), have been introduced into the market that are predominately used for reproduction of compressed audio tracks. One of the most popular PMP's is the iPod®, sold by Apple Computer, Inc. of Cupertino, Calif. The iPod has become popular because it has a relatively small form factor but can store many tens of gigabytes of audio files and other information on a hard disk drive stored within the PMP. Other PMPs additionally store video information for playback on a small display integrated into the device.

Most of the currently available audio devices are designed to be highly portable and to allow an individual to carry a relatively large number of audio tracks. However, because design of these devices has centered on portability, manufacturers tend to limit them so as to present the reproduced audio to a user only through monaural or stereo headphones that are plugged into the audio device. This means that, at best, these audio devices can only be used to reproduce audio tracks for a limited number of users, such as where one or more splitters are used to allow multiple users to plug headphones into the device. However, because the audio devices are typically battery powered, they are not capable of generating enough energy to power several pairs of headphones. Furthermore, increasing the number of users connected to a single device beyond one or two limits the device's portability.

One method alternatively employed by some in the prior art is to allow users to attach speakers to a portable media player. This allows multiple users to experience audio tracks at the same time. Because the power output of audio devices is typically relatively low, it is frequently advantageous for the speakers to include an amplifier which is powered by an external power source. Some in the prior art have created relatively small, battery powered or alternating current (AC) powered speakers for use with portable audio reproduction equipment. These speakers tend to take a lot of physical abuse during transportation, and frequently the cables and adapters used to connect the speakers to the audio device are not capable of withstanding such abuse.

One solution offered on the market is the original in Motion™, available from Altec Lansing Technologies, Inc., of Milford, Pa., and described in U.S. patent application Ser. No. 10/836,113 filed Apr. 30, 2004. The in Motion™ was a groundbreaking product which, for the first time, provided powered speakers integrated with a docking station for a portable media player in a relatively lightweight and compact portable package that folded to protect the speaker drivers during transport. While the in Motion™offered great advantages in terms of robustness, weight, portability, size, and ease-of-use, room for improvement in each of these qualities remains.

### SUMMARY OF THE INVENTION

The present invention is directed to a portable media reproduction system that substantially obviates one or more of the limitations and disadvantages of the related art. The invention provides a portable media reproduction system preferably consisting of a base component for supporting the portable media reproduction system, the base component having a docking component for communicatively coupling a media player device, and a speaker component operably connected and hinged to the base component, the speaker component being rotatable between an open position and a closed position. The open position exposes the docking component and directs the speaker component to an intended listener, and the closed position substantially aligns the speaker component and the base component such that the docking component is not exposed.

The base component is preferably designed to facilitate positioning the speakers at an optimum angle to enhance enjoyment of reproduced audio tracks. The audio amplifier can preferably be powered by batteries or an AC power source, although it will be apparent to one skilled in the art that purely battery powered and purely AC powered audio amplifiers can be substituted therefor without departing from the spirit or the scope of the invention.

The portable media reproduction system of the present invention is preferably designed to be communicatively coupled with one or more portable media player devices. In one embodiment, the present invention preferably includes an adapter by which the portable media reproduction system can be connected to one or more PMP's. By way of example, without intending to limit the present invention, the portable media reproduction system may include a docking cradle for attaching an iPod to the portable media reproduction system, thereby allowing the portable audio reproduction system to reproduce audio signals from the iPod. In an alternative embodiment, the docking cradle provided by the present invention may support multiple, interchangeable connection means, thus allowing a plurality of PMP's, satellite radio receivers, digital radio receivers, standard radio receivers, CD players, audio players, audio/video players or other portable media player devices to be communicatively coupled with the portable media reproduction system. The signal received by the system from the media playback device may be either digital or analog, and the player may be detachable from the system or permanently connected.

In addition to communicatively coupling through a docking port or the like, a preferred embodiment of the present invention also allows external devices, such as, but not limited to, audio signals from a computer, secondary audio device, or the like, to be communicatively coupled to the portable media reproduction system through a standard audio connector. Electronic mixing circuitry preferably allows audio signals from the external device to be input to, and reproduced by, the portable media reproduction system in conjunction with an audio signal from an attached PMP or other device.

It is to be understood that both the foregoing general description and the following detailed description are exemplary and explanatory and are intended to provide further explanation of the invention as claimed. Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a top perspective view of an embodiment of the present invention in a closed position.

FIG. 2 is a bottom perspective view of an embodiment of the present invention in a closed position.

FIGS. 3a through 3d show side elevational views illustrating the transition of the system of the invention from a closed position to an open position.

FIG. 4 shows a front perspective view of the system of the invention with a personal media player engaged therewith.

FIG. 5 shows a front elevational view of the system of the invention with a personal media player engaged therewith.

FIG. 6 shows a rear perspective view of the system of the invention with a personal media player engaged therewith.

FIG. 7 shows a bottom perspective view of the system of the invention in a closed position.

FIG. 8 shows a perspective view of a docking cradle of the invention in communication with a remote control.

FIGS. 9a and 9b show perspective views of two adapters in accordance with embodiments of the invention.

### DETAILED DESCRIPTION OF THE PREFERRED EMBODIMENT

Reference will now be made in detail to the preferred embodiments of the present invention, examples of which are illustrated in the accompanying drawings. For clarity, corresponding features are consistently labeled across the various views of the invention provided in the figures.

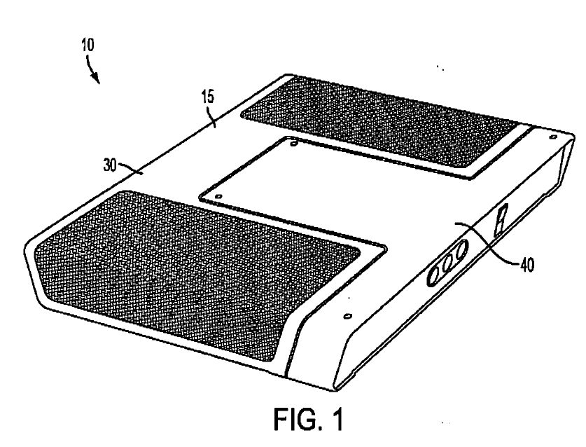

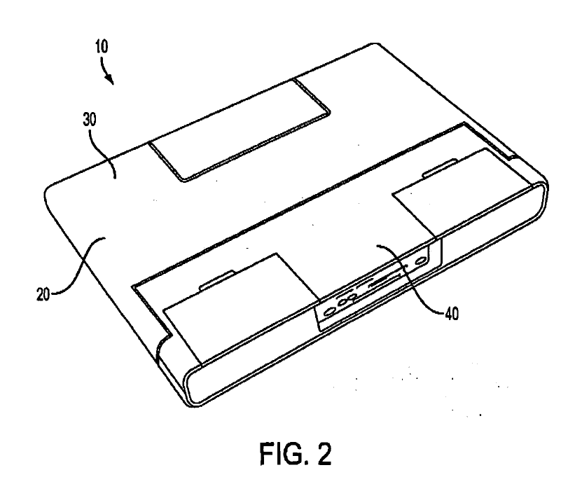

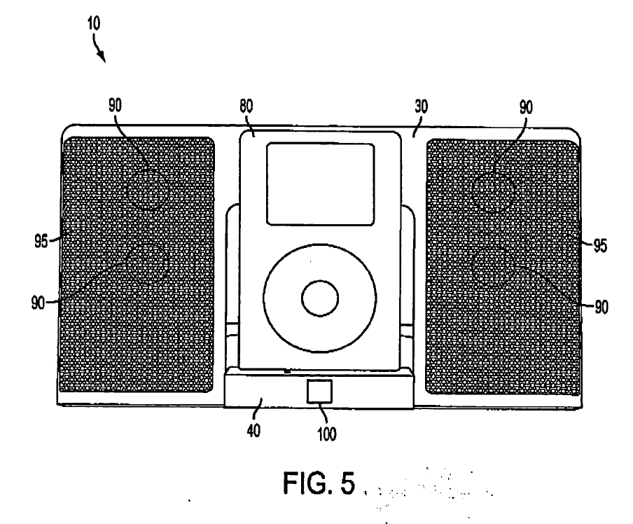

FIGS. 1 through 9b illustrate various views of a portable media reproduction system 10 according to a preferred embodiment of the present invention. Referring to FIGS. 1 and 2, portable media reproduction system 10 is shown in a closed position from a front view and a rear view, respectively. The closed position allows for a compact unit suitable for travel or space-saving needs. In the closed position, portable media reproduction system 10 is substantially rectangular, having a substantially planar top surface 15 and bottom surface 20. Although portable media reproduction system 10 is preferably one unit, portable media reproduction system 10 comprises two integrated components, a speaker component 30 and a base component 40, that are movable and rotatable with respect to each other. Those of ordinary skill in the art will recognize that the speaker component 30 may also be detached or detachable, or may itself comprise separate components for each of a plurality of channels of music that may be detached or detachable, without departing from the spirit and scope of the invention. Speaker component 30 and a base component 40 are communicatively coupled to provide a compact unit in the closed position and a stereo system in an open position. In one embodiment, when the portable media reproduction system 10 is in the closed position, the components are designed to mate with each other to form a generally solid form with generally smooth surfaces. The generally sold form and generally smooth surfaces make handling and transportation easier by preventing handles or edges from catching or impeding storage or movement.

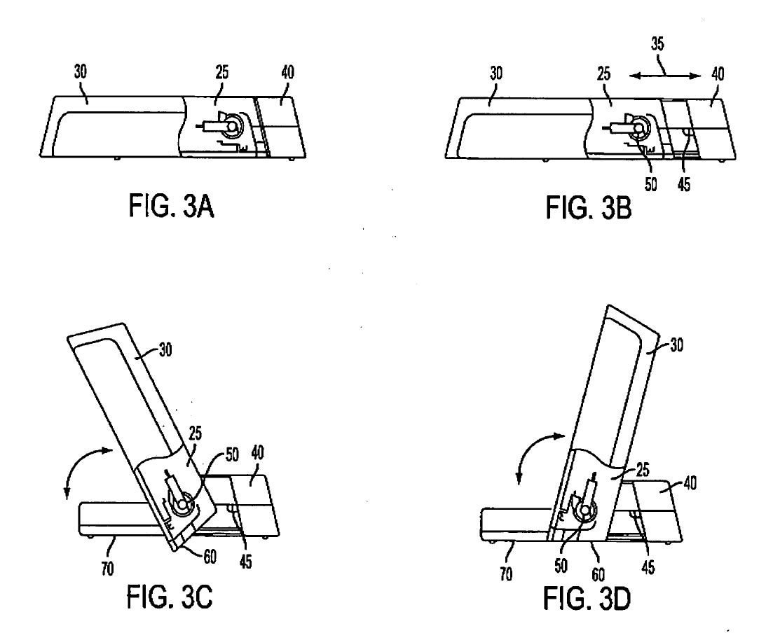

In one embodiment, the process for converting the portable media reproduction system from the closed position to the open position is as follows. Referring to FIGS. 3a-3d, side elevational views are shown which illustrate the transitioning of the system of the invention from a closed position to an open position. The base component 40 is pulled in a direction away from speaker component 30. Base component 40 and speaker component 30 are slidably engaged and utilize a spring to encourage an adjacent relationship. The spring allows for the return of the base component 40 and speaker component 30 in an adjacent position wherein the base component 40 abuts the speaker component 30 when no force is applied to separate the base component 40 and speaker component 30.

Base component 40 comprises a flange 45 extending from the base component 40 in a direction towards speaker component 30. When in the closed position, flange 45 is received by a recess (not shown) in speaker component 30. As a result, base component 40 and speaker component 30 are substantially locked (with respect to rotation) in the closed position by the engagement of the flange 45 in the recess (not shown). By pulling the base component 40 away from the speaker component 30, the flange 45 is no longer engaged with the recess (not shown), allowing the base component 40 and speaker component 30 to rotate in relation to each other.

Once the flange 45 is disengaged by applying a force separating base component 40 from speaker component 30, the components 30, 40 may be rotated with respect to each other about an axis extending through a pivot point 50. The components 30, 40 preferably rotate approximately 105 degrees until speaker component 30 engages base component 40, maintaining the speaker component 30 in an open position. Speaker component 30 is designed to face generally towards the intended listener when being rested upon a table, desk or other similar support surface. Accordingly, in one embodiment, when the base component 40 is supported on a support surface, the speaker component 30 maintains an angle of approximately 100 to 110 degrees with respect to a support surface (where zero degrees represents the angle when the speaker component is in a closed position). Speaker component 30 has a bottom surface 60 that is substantially aligned with a bottom surface 70 of base component 40 when in the open position.

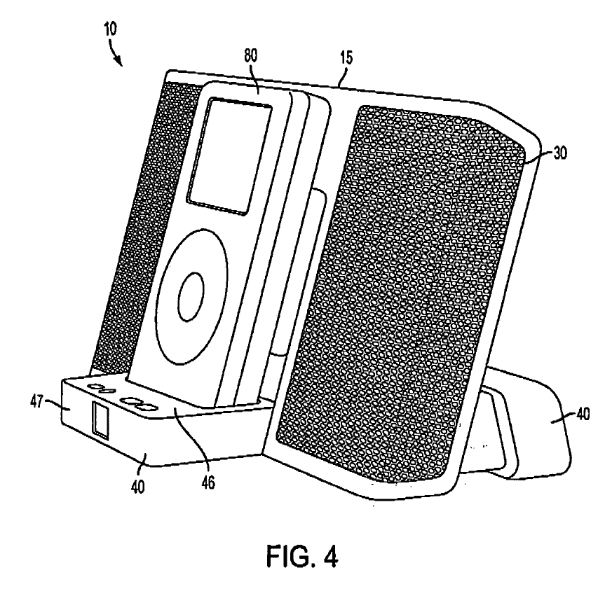

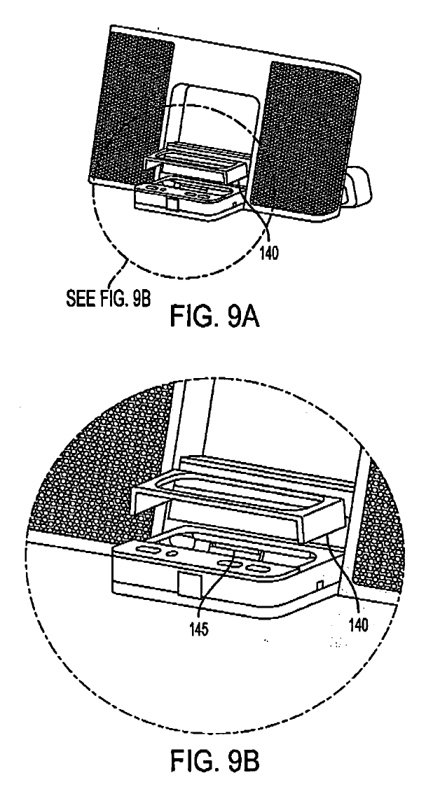

Referring to FIGS. 4 to 6, perspective and elevational views of the portable media reproduction system 10 in the open position are shown. A portable media player (“PMP”) 80, such as an iPod, is shown mounted on a docking port 46 of the base component 40. The docking port 46 provides a recess for receiving a PMP 80. Within the recess of docking port 46 is a connector or interface 145 (FIG. 9b) for communicatively coupling the PMP 80 to the portable media reproduction system 10. The surface 15 of the speaker component 30 provides additional support for the PMP 80 mounted in the docking port 46. When mounted in the docking port 46, the PMP 80 and the speakers 90 of the speaker component 30 are inclined at an angle intended to approximately face the listener. The PMP 80, when mounted in the docking port 46, makes a connection with the system 10 via an interface 145 (FIG. 9b) for transferring signals between the system 10 and the PMP 80. The interface 145 is an interface for transmitting electrical power and/or signals, and may be, e.g., the well known iPod data connector, or a connector that supports Universal Serial Bus (“USB”), Fire Wire (also know as IEEE-1394), or other standards for signal and data transmission. In yet another embodiment, the interface 145 may be a ⅛ inch stereo pin jack.

In one embodiment, the interface 145 is an electrical interface for transferring commands, electrical power, and audio signals between the system and the PMP. However, it will be recognized that other interfaces, such as an optical interface for transferring optically encoded digital signals, may be utilized either alternatively or in addition to an electrical interface of the presently preferred type. In applications where the audio signals are transferred between the PMP 80 and the system 10 in digital format, a suitable analog-to-digital converter such as an MPEG or MP3 decoder may be provided within housing of the system 10. In one embodiment, an audio amplifier, such as a 4-watt Class D digital amplifier, is provided within the housing of the system for driving the speaker drivers 90.

In one embodiment, the speaker component 30 has two arrays of drivers 90 positioned on the left and right sides of the centralized docking port 46. In an exemplary embodiment, drivers 90 are 28 mm neodymium drivers. The drivers 90 may be covered by a protective layer 95, such as a metal wire mesh, perforated aluminum grill, fabric or the like, to protect the drivers 90 during handling and use.

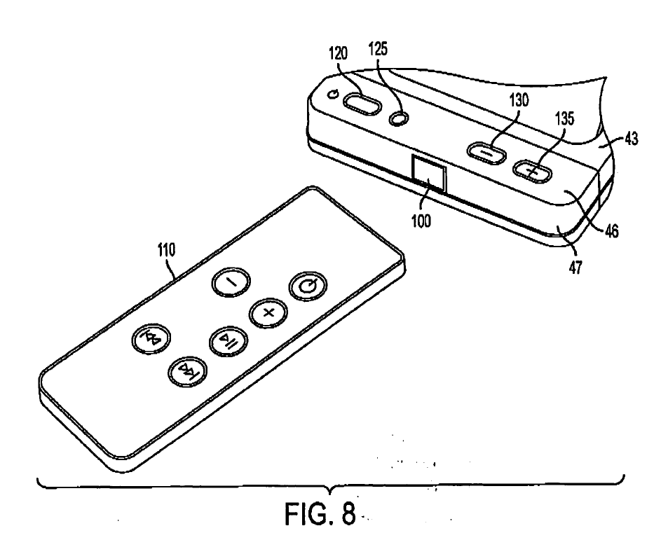

With reference to FIG. 8, on a top face 43 of the docking port 46 is a power button 120 and volume controls 130, 135. Volume controls 130, 135 allow for control of the volume level, whether or not the volume controls on the PMP 80 are operational upon connection to the portable media reproduction system 10. An LED 125 indicates the power status of the portable media reproduction system 10. When the power button 120 is actuated, a power on or off command may be sent to the PMP 80. In one embodiment, power continues to be applied to the PMP 80 via the interface 145 to provide a small current to charge the battery of the PMP 80 even when the power state of the system 10 is off.

On a front face 47 of docking port 46 of base component 40 is a sensor 100 for receiving signals from a remote control 110. The sensor 100 and the remote control 110 may use any well known method of communicating, such as, for example, infrared or RF (i.e., radio frequency). In one embodiment, remote control 110 may be used, e.g., to turn the power on or off, adjust the volume, play or pause an audio track, or advance to another audio track. Signals transmitted by the remote control 110 are received by the sensor 100 and are converted by circuitry within the system 10 into commands. The command may be transferred to the PMP 80 via the interface 145. In one embodiment, volume commands are not transferred to the PMP 80, but rather affect the amplification, and thus the playback level of the system 10.

Turning now to FIGS. 9a and 9b, a recess surrounding the connector on docking port 46 is configured to receive a bottom end and connecting portion of a PMP. In order to accommodate various sizes, form factors, and/or configurations of PMPs, an adapter 140 is provided. The adapter 140 may be positioned on docking port 46 and form a recess that sufficiently receives the PMP for associating with the connector. Adapter 140 may be provided in the form of a template that covers the edges of the recess in docking port 45 to provide a recess sized to appropriately accommodate a particular PMP. In one exemplary embodiment, adapter 140 is configured to receive an iPod. In another exemplary embodiment, adapter 140 is configured to receive an iPod Mini. In an alternative embodiment, the recess 46 accommodates a first type of PMP 80 having a bottom end of a given size and shape, while covering recess 46 with adapter 140 accommodates a different portable media player (not shown) having a bottom end with a different size and/or shape. In one embodiment, adapter 140 can additionally adapt the connector 145 to fit a different type of connection, or to accommodate a different electrical signal. The adapter 140 may be configured to accommodate any of a wide variety of portable media players without departing from the invention.

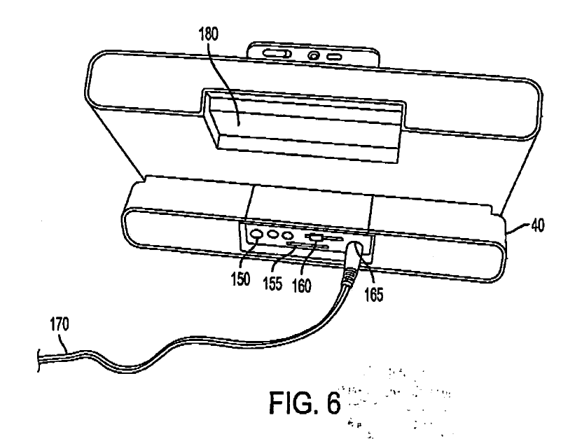

Referring to FIG. 6, on the rear side of base component 40 is an auxiliary input jack 150, a port 155 for connecting the PMP 80 to a personal computer, an override power switch 160, and a power jack 165 for providing a DC voltage through wire 170. The port 155 may be, e.g., an iPod data connector or other connector that conforms with a standard for data transmission, such as USB or Firewire. The port 155, in combination with the interface 145 (FIG. 9b), may allow the portable media reproduction system to replace a docking station traditionally associated with a portable media player device, thus enabling the device to synchronize with a computer, and may provide power from the personal computer to the system 10 and/or the PMP 80.

The auxiliary input jack 150 is an alternative method of providing audio signal input to the system 10. The auxiliary input jack 150 permits a portable media player (not shown) that is not compatible with the interface 145 to be used with the system 10. The portable media player (not shown) that is not compatible with the interface 145 may be rested in or on recess 46. In one embodiment, the system mixes the audio signal from the auxiliary input jack 150 with a signal from the interface 145, permitting a secondary sound source to be reproduced by the speakers 90. In one embodiment, an audio signal present on the auxiliary input jack 150 preempts an audio signal being received from the interface 145; this configuration would permit a secondary audio source to interrupt the signal coming from the interface 145.

The override power switch 160 is used as a second switch to turn the amplifier and other electronics of the portable media reproduction system off. When the override power switch 160 is in the off position power switch 120 (FIG. 8) has no effect; when the override power switch 160 is in the on position, however, power switch 120 (FIG. 8) controls the operational state of the device 10, as indicated by the LED 125. In one embodiment, the portable media reproduction system may have a further power override (not shown) that prevents having the portable media reproduction system 10 on when the system 10 is in the closed position. In one embodiment, the portable media reproduction system 10 automatically powers off when closed. These features can help prevent draining the batteries when the portable media reproduction system is not in use.

On the rear side of speaker component 30 is preferably provided a recess 180 configured to receive remote control 110 for storage thereof. The recess preferably receives the remote control 110 and retains it via a friction fit when the remote control is not in use.

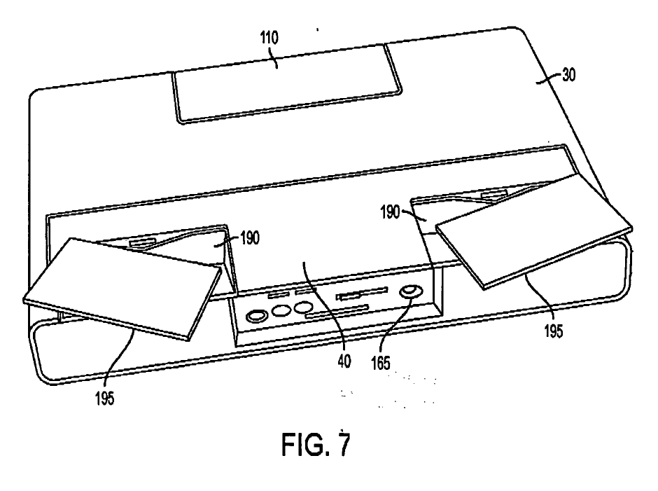

Referring to FIG. 7, the rear side of the portable media reproduction system 10 is shown in the closed position. Remote control 110 is shown as securely received by recess 180 such that the broad surface of the remote control 110 is flush with the broad surface of the speaker component 30, thus providing improved portability. A top side of base component 40 has two battery compartments 190 having lids 195.

When the PMP 80 is connected to the interface 145 of the portable media reproduction system 10, users can use the controls integrated with the PMP 80 to play music or audio/video content (with the audio portion of such content being reproduced by the speaker component 30), to synchronize files with or transfer data to a personal computer (not shown), or to recharge the PMP 80. While the PMP 80 is connected to the interface 145, the PMP 80 may receive power from the portable media reproduction system 10. In one embodiment, the portable media reproduction system 10 supplies power to media player device when the portable media reproduction system 10 receives power from an external power source, such as, but not limited to, an AC to DC converter (not shown), or to an external device capable (also not shown) of providing power to the portable media reproduction system 10. In one embodiment, the portable media reproduction system supplies power to the PMP 80 regardless of whether the portable media reproduction system 10 is operating on power from an external power source or from internal batteries. In addition to allowing the PMP 80 to function, power supplied by the portable media reproduction system 10 to the PMP 80 may also allow the device to charge any rechargeable batteries stored therein.

The power jack 165 allows the portable media reproduction system 10 of the present invention to be powered from an external power source, such as, but not limited to, an AC to DC converter or external battery pack. Alternatively or in addition to receiving power from an external power source, the portable media reproduction system can also be powered by one or more batteries, which may be stored within the portable media reproduction system 10, such as, but not limited to, in compartment or compartments 190. In one embodiment, rear surface of base component 40 includes two slidably removable covers 195 for access to battery housings.

In an embodiment in which rechargeable batteries are used, the rechargeable batteries are preferably recharged any time the portable media reproduction system 10 is connected to an external power source via the power jack 165. The portable media reproduction system 10 may also charge the batteries, and receive power, if a device is connected thereto via port 155. Where rechargeable batteries are used, the batteries should be of a capacity such that, if the portable media reproduction system 10 is disconnected from the external power source when the batteries are fully charged, the portable media reproduction system 10 can be powered and reproduce audio signals for several consecutive hours without needing to be recharged.

Power from the power jack 165, port 155, an externally connected device, and/or the batteries is preferably used to power a Class D or other audio amplifier (not shown) housed within the portable media reproduction system 10, as well as other aspects of the invention. A Class D amplifier is preferably used because of the relatively high efficiencies associated with such amplifiers. Such efficiencies provide reduced power consumption over conventional amplifiers, thereby improving the system's battery life. The amplifier is used to convert audio signals, preferably received via the interface 145 and/or from an external audio source connected to the system 10 through external audio input jack 150, into a signal capable of driving speaker drivers 90.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A portable media reproduction system comprising:
a base component for supporting the portable media reproduction system, the base component comprising a base support for engaging the base of a media player device; and,
a speaker component operably connected and hinged to the base component, the speaker and base components being rotatable between an open position and a closed position with respect to each other, the open position exposing the base support and angling the speaker component to a preferred angle with respect to the base component for listening by an intended listener and the closed position substantially aligning the speaker component and the base component whereby the base support is not exposed.

2. The portable media reproduction system in accordance with claim 1, further comprising: a docking component for communicatively coupling a media player device, wherein the docking component is not exposed when the portable media reproduction system is in the closed position.

3. The portable media reproduction system in accordance with claim 1, wherein the docking component is integrated with the base support forming a docking support.

4. The portable media reproduction system in accordance with claim 1, wherein the base component and the speaker component are slidably engaged.

5. The portable media reproduction system in accordance with claim 4, wherein the base component and the speaker component are biased toward one another into an abutting adjacent position when no force is applied to separate the base component and speaker component from one another.

6. The portable media reproduction system in accordance with claim 5, wherein when no separating force is applied to separate the base component and speaker component from one another, the hinge operably connecting the base component and the speaker component will not rotate.

7. The portable media reproduction system in accordance with claim 1, further comprising at least one user control on the base component; and wherein the open position additionally exposes the at least one user control, and the closed position is further characterized by the user control not being exposed.

8. The portable media reproduction system in accordance with claim 3, wherein the docking support is adapted to engage a portable media player having a first docking form factor, the portable media reproduction system further comprising at least one sizing adaptor engagable with the base component to enable the docking support to be adapted to engage a portable media player having second docking form factor.

9. The portable media reproduction system in accordance with claim 6, where the portable media reproduction system can be placed in the closed position when the at least one sizing adaptor is engaged with the base component.

10. A portable media reproduction system comprising:
a speaker component having at least one speaker driver and a recess;
a base component coupled to the speaker component for providing support to the speaker component such that the speaker component stands in a substantially upright position when the portable media reproduction system is in an open position and the base component is resting on a support surface; and,
a docking component extending from the base component and configured to be received by the recess of the speaker component when the portable media reproduction system is in a closed position, the docking component configured to communicatively couple to a media player device.

11. The portable media reproduction system in accordance with claim 10, wherein the docking component is configured to be communicatively coupled to a portable media player.

12. A method for utilizing a media player device with a portable media reproduction system having a base component coupled to a speaker component including at least one speaker driver, the method comprising the steps of:
rotating the speaker component and base component from a substantially aligned position to an open position, thereby exposing a base support for engaging the base of a media player device extending from the base component; and,
sending an audio signal from a media player device for reproduction on the at least one speaker driver.

13. The method of claim 12, further comprising the step of pulling the speaker component and base component away from each other to disengage a flange that prevents the speaker component and base component from rotating.

14. A portable media reproduction system comprising:
a docking component for communicatively coupling a media player device, the docking component including an interface for charging the media player device; and
a speaker component mechanically attached to the base component for receiving an audio signal and emitting amplified sound.

15. The portable media reproduction system in accordance with claim 14, wherein the interface applies current to charge the media player device when the portable media reproduction system is in an off state.

16. The portable media reproduction system in accordance with claim 14, further comprising a port for connecting the media player device to a personal computer.

17. The portable media reproduction system in accordance with claim 16, wherein the port provides power from the personal computer to the system for powering at least an amplifier.

18. The portable media reproduction system in accordance with claim 16, wherein the port provides power from the personal computer to the media player device.

19. The portable media reproduction system in accordance with claim 14, wherein the portable media reproduction system is powered by batteries.

20. The portable media reproduction system in accordance with claim 19, wherein the batteries are rechargeable batteries.

21. The portable media reproduction system in accordance with claim 20, wherein the interface is configured to receive a charge from the media player device.

22. The portable media reproduction system in accordance with claim 20, further comprising a port for communicating with a personal computer, the port receiving power from the personal computer and the power being used at least for recharging the rechargeable batteries.

23. The portable media reproduction system in accordance with claim 14, further comprising a removable adapter for adapting the docking component with at least a form factor of the media player device.

24. The portable media reproduction system in accordance with claim 14, further comprising first and second removable adapters for adapting the docking component with at least a form factor of the media player device and a form factor of a second media player device, respectively.

25. The portable media reproduction system in accordance with claim 14, further comprising a sensor for receiving signals from a remote control, the signals causing at least one command to be sent to the media player device via the interface.

26. The portable media reproduction system in accordance with claim 25, wherein the at least one command is a command selected from the group consisting of: a power on command, a power off command, a volume adjust command, a play command, a pause command, an audio track reverse command, an audio track advance command, a fast forward command and a reverse command.
